(19) United States
(12) Patent Application Publication
(10) Pub. No.: US 2025/0153785 A1
(43) Pub. Date: May 15, 2025

(54) Structural Element For Reducing A Flow Resistance

(71) Applicant: Matthias Reber, Matten (CH)

(72) Inventor: Matthias Reber, Matten (CH)

(21) Appl. No.: 18/839,240

(22) PCT Filed: Feb. 17, 2023
(86) PCT No.: PCT/EP2023/054106

§ 371 Date: Aug. 16, 2024

(30) Foreign Application Priority Data
Feb. 18, 2022 (CH) 000166/2022

(51) Int. Cl. B62D 35/00; A41D 13/00; B62D 27/06; E04H 9/14; F15D 1/00

(52) U.S. Cl. CPC B62D 35/00; A41D 13/0015; B62D 27/06; E04H 9/14; F15D 1/003

(57) ABSTRACT

A structural element for attachment to an outer skin of a vehicle, in particular a transport vehicle, a passenger car, a rail vehicle, an aircraft and/or a watercraft, includes a main fin and a first and a second secondary fin. These secondary fins are arranged next to the main fin such that a first channel is formed between the first secondary fin and the main fin and a second channel is formed between the second secondary fin and the main fin. The first channel and the second channel each have a change in cross-section such that when a fluid flows through the first channel or the second channel, a change in the flow velocity of the fluid occurs. In this way, the flow behavior of a fluid around the vehicle can be influenced and the flow resistance acting on the vehicle can be effectively reduced.

### TECHNICAL FIELD

The invention relates to a structural element for attachment to an outer skin of a vehicle, in particular a transport vehicle, a passenger car, a rail vehicle, an aircraft and/or a watercraft, which comprises a main fin and at least a first and a second secondary fin, which are arranged next to the main fin in such a way that a first channel is formed between the first secondary fin and the main fin and a second channel is formed between the second secondary fin and the main fin.

### STATE OF THE ART

The reduction of flow resistance on overflowing surfaces is a well-known problem in various technical fields. In vehicle construction, various approaches have been tested to reduce flow resistance. Typical approaches relate to the shape of the vehicle shell-flow resistance can be reduced by a suitable shape (e.g. teardrop shape or similar).

However, the scope for shaping is limited, particularly in the case of lorries, which should have the largest possible transport volume. Low flow resistance is also the aim for passenger cars. Here too, the scope for shaping the bodywork is limited from both a technical and an aesthetic point of view.

Therefore, due to the current vehicle shapes, the relative movement between the medium (air and/or water) continues to cause stalling and consequently turbulence, which increases the flow resistance and thus the energy consumption of the vehicle. This effect increases at higher speeds, as the air resistance increases in proportion to the square of the speed. This is particularly significant in long-distance transport.

There is therefore a desire to reduce the flow resistance of a vehicle-on the one hand for economic reasons, in particular to increase the cost efficiency of transport, and on the other hand for ecological reasons, as the energy requirements of vehicles are largely met from fossil fuels.

However, the problem of reducing flow resistance is not limited to road vehicles, but equally applies to rail vehicles, aeroplanes, watercraft such as boats, submarines, etc. or even suits such as sports suits for activities such as skiing. Even with static objects that are exposed to currents, e.g. house facades and water or air pipes, analogue considerations play a role. The problem here is not fuel consumption, but rather the effects of force, which can cause unwanted vibrations, noise or even damage, for example.

One approach to optimizing the flow behavior or reducing the flow resistance is to change the surface structure of a vehicle or other object. This can be achieved, for example, by using structures that are small in size compared to the vehicle or object. These structures interact locally with the medium flowing over the outer skin of the vehicle or object and thus influence the flow behavior.

Previous solutions generally comprise one or more simple localized elevations or depressions in the outer skin of the vehicle or in the surface of the object. Solutions with several protrusions of different sizes, which are designed as fins, are also known.

GB 2481640 A (Adil Shazad), for example, discloses accessories for vehicles in order to increase their energy efficiency. The accessory comprises a base plate, a central fin and a pair of side fins. This accessory can be attached to a surface of a vehicle to increase the efficiency of the vehicle by forming trailing vortices.

However, the known approaches to reducing the flow resistance of a vehicle or other object are not effective enough and lead to a relatively small reduction in flow resistance.

### SUMMARY OF THE INVENTION

A first task of the invention is to create a device belonging to the technical field mentioned at the beginning, which effectively reduces the flow resistance acting on a vehicle and can be manufactured simply and inexpensively.

The solution to the problem is defined by the features of claim 1. According to the invention, the first channel and the second channel each have a change in cross-section such that when a fluid flows through the first channel or the second channel, a change in a flow velocity of the fluid occurs.

The device is a structural element for attachment to an outer skin of a vehicle, in particular a transport vehicle, a passenger car, a rail vehicle, an aircraft and/or a watercraft. It comprises a main fin and at least a first and a second secondary fin. The secondary fins are arranged next to the main fin in such a way that a first channel is formed between the first secondary fin and the main fin and a second channel is formed between the second secondary fin and the main fin.

The change in the channel cross-section produces an effect on the fluid that is comparable to the effect of a pipe through which the fluid flows and whose internal diameter changes. According to a Venturi nozzle, for example, if the cross-section of the pipe is tapered, the flow velocity behind the taper increases, while the hydrostatic pressure of the fluid decreases at the same time. A similar effect occurs in the first and/or second channel of the structural element.

The change in the cross-section of the channel therefore preferably produces a change in the flow velocity when a fluid flows through the channel. This in turn makes it possible to generate advantageous changes in the flow behavior around a vehicle by changing the cross-section of the channel. In contrast to a closed pipe, the change in the flow within the channel also has an effect on the fluid flows above the channel.

This means that a suction or injector effect can also be generated above the structural element and above the ducts. Experiments and simulations have shown that when a structural element is attached to the outer skin of the vehicle, a negative pressure is created above the structural element during the journey, which directs cross flows towards the structural element. These are then redirected in the channels of the structural element and can thus be aligned with the main direction of travel of the vehicle. Here again, the change in cross-section also affects the diverted cross-flows.

Surprisingly, it has now been found that a change and in particular a widening of the channel cross-section along the direction of flow has a positive effect on the flow resistance of a vehicle and can therefore reduce energy consumption (e.g. petrol, diesel, electrical energy, etc.). The flow resistance that the vehicle experiences due to the surrounding fluid is thus effectively reduced. This in turn allows the vehicle to cover a distance with reduced fuel consumption compared to travelling over the same distance and at the same speed, but without corresponding flow elements on its outer skin.

The structural element is a component that extends over the outer skin of the vehicle. As a result, the fluid surrounding the vehicle flows around the structural element in addition to, or instead of, the outer skin as soon as the vehicle moves. The structural element changes the interaction between the vehicle and the fluid through the reaction of the flow element to the fluid flows that form around the vehicle when it moves. In this way, the flow element can change the flow resistance exerted on the vehicle through fluid mechanical effects. For example, the overall flow resistance of the vehicle can be partially reduced in the main direction of travel of the vehicle. Fluid mechanical forces acting on parts of the outer skin of the vehicle can also be modified in such a way that the occurrence of oscillations or vibrations is reduced or suppressed.

A vehicle refers to any type of device that moves through a fluid that at least partially surrounds it. In particular, it is a transport vehicle, a passenger car, a rail vehicle, an aeroplane and/or a watercraft. As a rule, the vehicles have one or more main directions of travel. They are therefore intended to move mainly in this main direction of travel through the fluid partially surrounding them.

The term outer skin is understood here to mean at least one area of a vehicle surface along which the fluid flows while the vehicle is travelling in the main direction of travel. This results in a relative movement between the fluid and said outer skin while the vehicle is travelling in the main direction of travel. The outer skin is essentially flat and smooth, at least in a neighborhood of the structural element. The outer skin may well have curvatures. Such curvatures preferably have a large radius of curvature in the area of the structural element, which is in particular greater than a length of the structural element, in particular greater than five times the length of the structural element.

A fluid, in turn, is to be understood as any flowing substance which is capable of flowing around a body. In the context of the present application, this is the fluid that flows around a vehicle when it is travelling, in particular air or water. When travelling, a vehicle typically experiences a flow resistance from the fluid flowing around it, which flow resistance slows down the vehicle and must be overcome by it. In the case of watercraft in particular, several fluids, in this case water and air, can also flow around the vehicle and each exert a flow resistance on the vehicle. The skilled person is aware that the fluid can also be inhomogeneous and can include, for example, aerosols, smoke, mist, etc.

A relevant contribution to the flow resistance is the induced resistance. The vehicle generates movements within the fluid that are not parallel to the main direction of travel. The kinetic energy of these fluid movements is at least partially extracted from the vehicle. These fluid movements, also referred to below as transverse flows, are generally undesirable from a fluidic point of view. In a transport vehicle, for example, equalizing flows can occur on the upper side at right angles to the main direction of travel, which are caused by air displacement.

In the following description, the terms top, bottom, above, below, upper side, underside or similar are used.

The structural element comprises a contact surface, which in particular represents the surface with which the structural element comes into contact with a vehicle outer skin. The contact surface is preferably flat. In certain embodiments, the structural elements can be at least slightly elastic or plastically deformable in such a way that they can be attached to a non-flat surface, for example a curved surface, in such a way that the entire contact surface makes contact with the surface. In this situation, the contact surface essentially takes on the shape of the surface and therefore no longer forms a plane. In variants, however, the contact surface of the structural element can also be non-planar.

The part of the structural element that faces away from the contact surface is the upper side of the structural element. Similarly, its underside is the part of the structural element that faces in the same direction as the support surface. A plane, called the main plane, is introduced to orientate lengths and heights. This main plane has the same orientation as the support surface and contains it as long as the structural element is not deformed. Unless otherwise specified, a height is the smallest distance of a point from the main plane. If height is specified as a direction, this is a direction perpendicular to the main plane.

A length in turn refers to distances between two points on the structural element that have the same height, i.e. run parallel to the support surface. If the length is again used to indicate the direction, this denotes the direction parallel to the support surface or to the main plane introduced above.

A fin, i.e. the main fin or a secondary fin, refers to a continuous area of the structural element that is located on the upper side of the structural element and rises above it. The height of the fin increases from the edge area of the fin towards the fin. A fin is able to at least partially displace the relevant fluid and thus redirect it. The length of a fin is the maximum length parallel to the contact surface that can be found between two points located on the fin. The height of the fin along its length is the maximum height that can be found at a position along its length and is measured perpendicular to the bearing surface.

The main fin is the fin that is preferably arranged in a central area of the structural element and/or has the greatest height and/or the greatest length among the fins. It is particularly preferable for the main fin to be a fin arranged in the central area of the structural element which has both the greatest height and the greatest length.

A secondary fin is in turn a further fin that is different from the main fin. The side walls of the secondary fin are different from the side walls of the main fin or other secondary fins.

The secondary fin or secondary fins are preferably arranged essentially parallel to the main fin.

A channel refers to a spatial area above the top of the structural element, between the main fin and a secondary fin, through which a fluid can flow. The channel is bounded in a first direction by the side walls of neighboring fins. In a second direction transverse to this first direction, along the channel, the channel is not delimited against a fluid, but is open. Downwards (towards the main plane), the channel is also bounded by the surface of the flow element or, after attachment to a vehicle, by its outer skin. Upwards, i.e. pointing away from the main plane, the channel is not necessarily limited, preferably the channel is not or at least not completely limited upwards. The spatial area referred to as the channel is continuous with a positive cross-section. The length of the channel corresponds to the length of the shorter fin that delimits the channel.

The cross-section is a section of the channel along a plane that is perpendicular to the direction of the channel length. The channel cross-section is defined by a boundary line between the crests of the fins that delimit the channel. A positive channel cross-section exists if there is a continuous area within the cross-section that is delimited by the structural element or the side walls of the fins delimiting the channel in such a way that it can be completely enclosed by the boundary line introduced above and, at most, the main plane introduced above.

A change in cross-section refers to a change in the duct cross-section, whereby the duct cross-section at a first position along the duct length differs from a duct cross-section at a second position along the duct length. This means that the channel cross-section at the first position is not identical to the channel cross-section at the second position, preferably not congruent and in particular preferably not equal in area.

Preferably, the main fin and the first secondary fin as well as the main fin and the second secondary fin are not aligned parallel to each other. In variants, the main fin and the first secondary fin or the main fin and the second secondary fin can also be aligned parallel to each other. In this case, for example, the main fin can have a change in cross-section along the longitudinal direction, which means that the first channel and the second channel also experience a change in cross-section along the longitudinal axis.

Preferably, the first channel and/or the second channel are free of curvature, i.e. the side walls (essentially at right angles to the contact surface) of the main fin and, in particular, of the first and second secondary fins are designed in such a way that there is no deflection of the fluid within the first and second channels. This minimizes resistance to the fluid. In variants, the first channel and/or the second channel can comprise a bend, which allows the fluid flow to be deflected parallel to the support surface.

Preferably, the main fin and, in particular, the first and second secondary fins are convex in a sectional plane parallel to the support surface. This means that the main fin and in particular the first and second secondary fins preferably have no lateral indentations or the like. Tests have shown that this creates a structural element with which flow resistance can be reduced to a particularly high degree. In variants, the main fin and in particular the first and second secondary fins can also comprise concave areas and thus in particular indentations, grooves and the like.

Preferably, a maximum width transverse to the longitudinal direction of the first channel and/or the second channel increases in the direction of the longitudinal direction, preferably over the entire length of the first channel and/or the second channel, at an opening angle of between 0.1° and 20°, preferably between 0.5° and 10°, more preferably between 2.5° and 4.5°. On the basis of many prototypes and experiments in the flow channel, it could finally be surprisingly shown that a particularly effective reduction of the flow resistance can be achieved with the above opening angles.

The maximum width of the channel is measured parallel to the support surface, transverse to the longitudinal direction of the channel. If the first and or second channel has two parallel boundary walls, these boundary walls are arranged at an opening angle to each other as described above. In principle, the first and/or second channel can have a shape that cannot be described in simple geometric terms. A shape of the cross-section of the channel is therefore typically not necessarily geometrically similar at different points along the longitudinal direction. The maximum width therefore does not necessarily run along the longitudinal axis over a constant height above the support surface. The maximum height at which the maximum width of the channel can be determined at a location in the longitudinal direction is preferably determined by the height of the lower fin at this location.

Particularly preferably, the maximum width transverse to the longitudinal direction of the first channel and/or the second channel increases continuously in the direction of the longitudinal direction. In variants, the first channel and/or the second channel can also have one or more areas in the longitudinal direction in which the maximum width is constant.

Preferably, the main fin ridge is not parallel to the first secondary fin ridge and/or the second secondary fin ridge. In particular, a main fin comb is preferably at an angle of between 0.1° and 20°, preferably between 0.5° and 10°, in particular preferably between 2.5° and 4.5° to the first secondary fin comb or the second secondary fin comb. In variants, the main fin ridge can also be aligned parallel to the first secondary fin ridge or the second secondary fin ridge.

Advantageously, the channels have a curved channel bottom in a center area along a respective longest channel length in a cross-section. This means that the cross-section of the channel is at least partially curved upwards.

Such a shape effectively channels a flow while at the same time minimizing the wall surface that this flow touches (while the flow volume of the fluid remains the same). This in turn minimizes the friction that occurs when the flowing fluid comes into contact with the channel floor. At the same time, this shape also allows for a stable design of the structural elements.

Alternatively, the channel can also have a rectangular cross-section, for example. In this case, however, the area of the channel floor is increased while the channel volume remains the same, which also increases friction.

Preferably, the main fin has a change in cross-section in the direction of the first channel and/or the second channel (i.e. in the longitudinal direction). Thus, the change in cross-section of the first and/or the second channel can be achieved at least in part by the shape of the main fin. Particularly preferably, the main fin has a change in cross-section along the longitudinal direction such that a height of the main fin changes. Further preferably, the main fin has a change in cross-section along the longitudinal direction in such a way that the width of the main fin changes.

In variants, the change in cross-section of the main fin can also be omitted. The change in cross-section of the first and/or second channel can also be achieved by orientating the main fin relative to the first or second secondary fin (e.g. non-parallel arrangement of the main fin to the first or second secondary fin). Furthermore, the change in cross-section can also be achieved solely or additionally by changing the cross-section of the first and/or second secondary fin.

In a preferred manner, the main fin, in particular also the first secondary fin and the second secondary fin, has a width in an end region of the fin length and at a locally average fin height that corresponds to at least 30%, preferably at least 40% of the channel width. An end region of the fin length refers to a position along the respective fin length that is no further than 30% away from one end of the fin. The local mean height is a height between 30% and 70% of the maximum fin height at this position. The fin width is in turn the maximum extension of the fin at this height and length position parallel to the contact surface and transverse to the fin length. The channel width, in turn, is the width of the channel (or its clear dimension) transverse to the length of the main fin and parallel to the bearing surface, at the same height. Particularly preferably, the main fin, and especially the first and second secondary fins, have a cross-section in an end region of the fin length that corresponds to at least 30%, especially 40%, of the channel cross-section.

The advantage of these extensions is that the fin is also relatively wide in relation to the channel width. This means that the (first or second) channel itself, together with the neighboring fins, i.e. the main fin and the first or second secondary fin, is narrower than the space in front of the structural element. This means that currents that were previously able to develop at this height are enclosed in a narrower space when they enter the channel. This in turn results in a Venturi effect or a suction effect, as the duct opening acts like a cross-sectional taper on the flow. It therefore causes an increase in the flow velocity and a decrease in the hydrostatic pressure of the fluid. This in turn can direct further flows, in particular cross flows, towards the channel opening, whereby these are then aligned in the channel to the main direction of travel of the vehicle.

Preferably, the main fin comprises a main fin ridge and the first secondary fin comprises a first secondary fin ridge, wherein a minimum distance between the main fin ridge and the secondary fin ridge is between 50% and 300%, preferably between 100% and 150% of a maximum height of the main fin.

The fin ridge is a continuous line of the highest fin height, at least over at least 50%, preferably over 100% of the fin length. The advantage of this variant is that the channel is thus similar in height to its width. A flow of a certain volume is thus exposed to the smallest possible channel surface.

Alternatively, the fins can also be spaced further apart or closer together. However, this increases the channel surface area per flow volume/flow cross-section, which in turn increases friction.

Preferably, the shape of the main fin is symmetrical to a plane that is perpendicular to the support surface and contains the fin ridge. This ensures that no cross currents form above the main fin and that the force effect is symmetrical in currents along the main fin.

Preferably, the main fin ridge of the main fin, and in particular a first secondary fin ridge of the first secondary fin and a second secondary fin ridge of the second secondary fin, describes a curve in a plane at right angles to the bearing surface, wherein the curve comprises a first curve section and a second curve section directly adjoining the first curve section, wherein the first curve section has an average angle of inclination between 5° and 15°, in particular between 7° and 9°, particularly preferably between 7.4° and 8.0°. Particularly good results were achieved with a gradient angle of between 7.6° and 7.8°, especially preferably at around 7.7°. The term mean angle of inclination means that the inclination of the first section between the bearing surface of the structural element and the highest point of the curve (i.e. the maximum height of the main fin) is determined. In between, the curve can deviate slightly from a straight line with the above gradient, in particular in a range of less than +/−20%, in particular less than +/−10%, especially preferably less than +/−5% of the maximum height of the curve. Preferably, the main fin crest has an indentation which has a depth of less than 20%, in particular less than 10% of the maximum height of the main fin. Tests have shown that this can achieve better results in reducing the flow resistance. In variants, the indentation can also be omitted. Preferably, the first curve section has a waveform with an amplitude of less than 20%, preferably less than 10% of the maximum height of the main fin. Further preferably, the waveform comprises exactly two wave crests. Preferably, a length of the first curve section projected vertically onto the support surface is at least 75%, preferably at least 85%, in particular between 88% and 92% of the total length of the main fin.

In variants, the first curve section can also have an average angle of inclination of less than 5° or more than 15°. The length of the first curve section projected onto the contact surface can also be less than 75% of the total length of the main fin. The first curve section can also run in a straight line or have other deviations from a straight line.

Preferably, the curve of the main fin ridge in the area of the second curve section describes a circular arc over an angle between 85° and 95°, in particular approximately 90°. The curve does not necessarily have to follow the exact shape of a circular arc, but can preferably deviate from the ideal circular arc line in a range of less than +/−10%, in particular less than +/−5%, especially preferably less than +/−2% of the maximum height of the curve. In variants, the second curve section can also be shaped differently.

Particularly preferably, the structural element comprises a third secondary fin and a fourth secondary fin, wherein the third secondary fin is arranged directly next to the first secondary fin such that a third channel is formed between the third secondary fin and the second secondary fin, and wherein the fourth secondary fin is arranged directly next to the second secondary fin such that a fourth channel is formed between the fourth secondary fin and the second secondary fin. An increase in the number of channels results in more effective guidance of the fluid flows. As the channels are open towards the top in particular, a channel also influences the flow behavior of the fluid located near the channel. The third and fourth channels can thus generate a secondary flow, which also influences the fluid flow within the first and second channels. In addition, the third and fourth secondary fins, as well as the third and fourth channels, allow additional variation of the specific shape, e.g. based on their respective distance from the main fin. For example, larger and smaller channels can be combined and cross flows on the vehicle can be gradually absorbed and diverted. The shapes of the fins can also be varied in such a way that fins further out, which are exposed to stronger cross currents, oppose these currents with a more inclined side wall than, for example, the main fin. The main fin itself can then take on a shape that effectively acts on the currents that run largely parallel to the main fin. Finally, the larger number of fins or channels means that a sufficiently efficient reduction in flow resistance can be achieved with relatively few structural elements per unit area, while the individual structural elements are still relatively small.

Preferably, the third and fourth secondary fins are each asymmetrical to a plane that is perpendicular to the support surface and in particular contains the respective fin ridge. In particular, the height of the second or third secondary fin increases less steeply towards the fin ridge on the side of the second or third secondary fin facing away from the main fin than on the opposite side. This ensures that cross flows from the structural element are effectively channeled into the channels. In turn, the flows are held in the channels by the steeper walls and thus effectively deflected. Alternatively, the second or third secondary fin can also have a different shape, e.g. a shape symmetrical to the above-mentioned plane.

Alternatively, additional secondary fins and channels can also be dispensed with.

Advantageously, the first channel and the second channel are longer than the third channel and the fourth channel. The length here refers to the maximum length of the respective channel. As side flows transverse to the main direction of travel of the vehicle swirl the channeled flows again, shorter channels can deflect these side flows in a targeted manner, while the channels, which are partly formed by the main fin, have their full effect on the flows that already run parallel to the main direction of travel of the vehicle.

Alternatively, the channels can also be of the same length. Furthermore, the outer channels (e.g. the third and fourth channels) can also be longer than the inner channels (in this case the first and second channels).

In a preferred embodiment, the structural element is mirror-symmetrical to a plane extending transversely to the main fin. By transverse to the main fin, it is meant that the plane of symmetry is essentially perpendicular to the length of the main fin and perpendicular to the contact surface of the structural element. This results in a structural element that takes account of a changing main direction of travel of the vehicle. This means that the structural element has the same effect on flows, regardless of whether the vehicle is travelling forwards or backwards, for example. Vehicles that have two main directions of travel, such as many trains, also benefit from such a design. Preferably, a corresponding structural element has the shape of a double wedge (i.e. essentially the shape of an isosceles obtuse-angled triangle) in cross-section perpendicular to the contact surface and parallel to the longitudinal direction. In particular, according to the above embodiment, the main fin ridge (and analogously the first and second secondary fin ridges, as well as any further secondary fin ridges) can correspond to the first curve section and thus deviate to a certain extent from the ideal shape of an isosceles triangle. Tests have shown that this creates a compromise structural element that leads to a considerable reduction in flow resistance for opposing main directions of travel.

In an alternative preferred design, the structural element does not have such symmetry. For vehicles such as cars or lorries, the flow resistance when reversing is normally insignificant. A flow element that is particularly optimized for a main direction of travel is advantageous here.

Preferably, the structural element is mirror-symmetrical to a plane running parallel to the main fin, which is in particular perpendicular to the contact surface and parallel to the longitudinal direction. This means that the plane contains a straight line that runs parallel to the main fin or that the plane contains the maximum length of the main fin. Such a structural element reacts in the same way to cross flows from both directions transverse to the main fin. The frictional forces caused by the flow element itself from flows parallel to the main fin are also symmetrical. If the flow element is attached to a vehicle in such a way that the main fin is parallel to the main direction of travel, no torque acts on the structural element. This in turn reduces the forces on the connection between the vehicle and the structural element.

Alternatively, especially for selected areas of the vehicle, such as lateral areas, a structural element that is not symmetrical in this plane can also be useful. Such an element can be designed with the foreknowledge that cross-flows will preferably attack from one direction and then deflect these cross-flows in a targeted manner. This can be useful, for example, along an edge of a vehicle aligned in the direction of flow. Other applications are known to the skilled person.

In a preferred embodiment of the invention, the main fin, and preferably all secondary fins, have a tangent angle of at most 30°, preferably between 10° and 20°, at one end to a support surface of the structural element. This means that a flat outer skin of a vehicle will also form such a tangent angle with the fins. Tangent angle here means the smallest angle that a tangent can form with a straight line running parallel to the bearing surface of the structural element, whereby this angle is at most 10% of the maximum length of the fin from one end of the fin. The term tangent in turn refers to a straight line that touches but does not intersect the fin ridge. This has the advantage that when the structural element is attached to a vehicle, the fin end is pointed towards the outer skin of the vehicle. This is able to divert a fluid flow without generating turbulence.

Alternatively, the main fin or the main fin and one or all secondary fins may have a different tangent angle to an underside of the structural element.

Preferably, a maximum height of the secondary fins increases towards the main fin and, in particular, the main fin has the highest maximum height. This means that the maximum height of the secondary fins is greater the closer the secondary fin is to the main fin. The outer secondary fins therefore have the lowest height. In particular, the main fin has the highest maximum height, i.e. a maximum height that is higher than the maximum height of all secondary fins. Particularly preferably, the height of the fins is also selected along the entire length of the main fin so that it increases towards the main fin.

This ensures that cross currents that do not hit the structural element in the direction of the channels are gradually absorbed and deflected by the fins. In this way, cross flows can also be absorbed by several channels without the channels further inwards being too much in the slipstream of the outer channels.

In a preferred embodiment, a height of the main fin and in particular a height of the first, second, third and fourth secondary fins increases steadily over at least 60%, in particular at least 80% of an entire length of the main fin or secondary fin, wherein in particular the main fin and preferably the first, second, third and fourth secondary fins have an essentially wedge-shaped side profile.

Such a constantly increasing height of the fins allows the fins to be attached to a vehicle in such a way that a fluid flow against the main direction of travel of the vehicle meets a constantly increasing fin height. This effectively guides the fluid flow without creating localized turbulence in the fluid near the channels.

Alternatively, the fin height can also have a different shape. However, if the shape is incorrectly selected, this would have the disadvantage that turbulence could still occur above the flow element, which means that the channels may be less effective in guiding the fluid flow.

Preferably, the same number of secondary fins are located on both longitudinal sides of the main fin. Longitudinal sides refer to the two sides of a plane that is spanned by the height and maximum length of the main fin. This arrangement of secondary fins also ensures the same number of channels on both sides of the main fin. If such a structural element is aligned with the main fin in the main direction of travel, a largely symmetrical force effect is created on the structural element, which means that it does not experience any strong torque. Similarly, the structural element will have little or no asymmetrical reaction on the vehicle, which means that the structural element can be positioned very freely on the vehicle's outer skin.

Alternatively, different numbers of secondary fins can be located on both longitudinal sides of the main fin.

Preferably, all fins each have a fin end that is located within an area whose extension parallel to the length of the main fin is at most 20% of the length of the main fin. This means that along the main fin, the ends of the secondary fins on at least one side of the main fin are all on the same length along the main fin. With suitable alignment of the structural element on the outer skin of a vehicle, it can be achieved that all ends of the fins (main and secondary fins) are in the same position relative to the main direction of travel of the vehicle and point away from it. In the case of vortex generation by the ends of a fin facing away from a fluid flow, this ensures that the vortices do not hit a neighboring fin and disturb or influence the flow around it.

Alternatively, the ends can also be arranged differently, for example staggered. In the case of a flow element that is provided symmetrically for two opposing main directions of travel, the turbulence must be accepted.

A length of the first, second, third and fourth secondary fins is particularly preferably less than a length of the main fin and the length of the secondary fins increases towards the main fin. This means that the maximum length per fin increases with proximity to the main fin and the length of the main fin is greater than the length of all secondary fins. In addition to the length of the channels, the different lengths of the fins can also ensure that the channel ends are angled in relation to the fin length. This means that cross currents are better absorbed into the channels and orientated towards the main direction of travel. Alternatively, the fins can also have the same length.

In a preferred embodiment of the invention, a length of the structural element in the direction of the first channel is between 30 mm and 120 mm, preferably between 50 mm and 100 mm, more preferably between 80 mm and 90 mm. In a particularly preferred embodiment, the length is between 80 mm and 86 mm, in particular approximately 83 mm. By a length is meant the maximum length of the structural element parallel to, or at an angle of up to a maximum of 20° to, the maximum length of the first channel. In this extension, the structural element is effective in speed ranges that are relevant for the operation of vehicles. It is also large enough to be easy to handle before it is attached to the vehicle. The installation itself is also easier than with smaller elements, for example. Cleaning is also simplified compared to smaller elements. Larger structural elements, on the other hand, are more expensive to manufacture, for example. In addition, larger elements exert greater forces per structural element on the structural element or on the vehicle. This can make attachment to the vehicle more difficult. A further advantage of this size is that such a structural element can be produced in a 3D printing process and does not exceed the usual size of components that a 3D printer can produce. At the same time, the smallest resolution of the 3D printer is not undercut.

Alternatively, the structural element can also have a length of less than 30 mm or a length greater than 120 mm.

Preferably, the width of the structural element transverse to the first channel is between 20 mm and 100 mm, preferably between 40 mm and 80 mm, more preferably between 60 mm and 70 mm. In a particularly preferred embodiment, the width is between 61 mm and 67 mm, in particular approximately 64 mm. By the width transverse to the first channel is meant here the maximum length of the structural element in a direction that is transverse, or at an angle of between 90° and 80°, to the maximum length of the first channel. This width has the advantage that it is possible to effectively influence the flow characteristics of a vehicle while at the same time ensuring simple maintenance and installation, low frictional forces and low costs.

Alternatively, the width of the structural element transverse to the first channel can also be less than 20 mm or more than 100 mm.

Preferably, a maximum height of the main fin is between 5 mm and 20 mm, preferably between 7 mm and 14 mm, more preferably between 9 mm and 11 mm. In a particularly preferred embodiment, the maximum height is approximately 10 mm. Such a height has a number of advantages. The structural element thus rises sufficiently above the outer skin of a vehicle to effectively and positively influence its flow behavior. At the same time, the structure of the vehicle, i.e. its visual impression and design, is not disturbed by the structural element. In addition, the structural element generally does not protrude over any aerials on the vehicle. Furthermore, the vehicle's susceptibility to wind is not increased in any relevant way by a structural element of this height. Likewise, structural elements of this design can even be placed on parts of the outer skin that are located in front of the driver's cab without blocking the driver's view.

Alternatively, a structural element can also be created with a height of less than 5 mm. This may have the disadvantage of being less effective than higher fin heights. Structural elements higher than 20 mm are also possible. However, this could increase the vehicle's susceptibility to wind.

Preferably, the maximum height of the first and second secondary fins is between 5 mm and 20 mm, preferably between 6 mm and 12 mm, more preferably between 8 mm and 9 mm. In a particularly preferred embodiment, the maximum height is approximately 8.5 mm. In variants, the maximum height of the first and second secondary fins can also be less than 5 mm or greater than 20 mm.

Preferably, the maximum height of the third and fourth secondary fins is between 3 mm and 20 mm, preferably between 4 mm and 12 mm, more preferably between 5 mm and 7 mm. In a particularly preferred embodiment, the maximum height is approximately 6 mm. In variants, the maximum height of the third and fourth secondary fins can also be less than 3 mm or greater than 20 mm.

In a preferred embodiment of the invention, the mass of the structural element is at most 20 g, preferably at most 15 g. Since the total mass of the vehicle also influences the fuel consumption, a structural element with a low mass is in principle advantageous over a structural element that is too heavy. However, the structural element should retain its dimensional stability even under relevant loads, as deformation would affect its flow properties. Structural elements weighing more than 20 g are also possible, but their contribution to the vehicle weight becomes more relevant. In particular, structural elements that are made entirely or partially from a plastic can achieve this weight.

Preferably, the structural element comprises a fastening device for attaching the structural element to the outer skin of a vehicle, in particular a transport vehicle, a passenger car, a rail vehicle, an aircraft and/or a watercraft. A fastening device is an area of the structural element which comprises a configuration in which the fastening device is non-detachably connected to the outer skin of a vehicle. In the connected state, at least one surface of the fastening device touches the outer skin of the vehicle and cannot be detached from this outer skin of the vehicle. By non-detachable, it is again meant that at least one regular journey with the vehicle does not generate any flow, vibration or frictional forces that are suitable for detaching the connection.

The fastening device can comprise functional parts that enable such fastening. For example, these can be clamps with which the structural element can be clamped to the outer skin of the vehicle. Screws and receptacles for these screws are also possible, for example. Another alternative is a prepared adhesive surface with a peel-off film. This peel-off film (which is not part of the structural element) is then removed before attachment and the structural element can then be bonded to the outer skin of the vehicle.

Alternatively, the structural element does not include a fastening device. For example, it can be placed or clamped in a designated indentation on the prepared vehicle outer skin. However, this only works with easily predictable flow forces or appropriately designed vehicles. The structural element can also be attached to the outer skin of the vehicle with an adhesive. Several structural elements can also be attached to the outer skin using an outer film (adhesive films). Other variants are known to the skilled person.

In a particularly preferred embodiment of the invention, the fastening device comprises at least one permanent magnet for fixing the structural element to the outer skin of a vehicle. Permanent magnets are all hard magnetic materials. Such a magnet makes it possible to attach the structural element to magnetic outer skins of vehicles without manipulating the outer skin of the vehicle itself (e.g. by drilling holes). The magnet can, for example, be inserted positively within a structural element. A structural element consisting exclusively of hard magnetic material is also possible.

Alternatively, the fastening device can also have a different design and include clamps, for example (see above). Alternatively, the structural element can also comprise no fastening device.

A further aspect of the invention is a vehicle comprising an outer skin which is exposed to a fluid, in particular water and/or air, while travelling in a main direction of travel, wherein at least 5, preferably at least 50, particularly preferably at least 250 structural elements according to the above description are attached to the outer skin of the vehicle in order to reduce a driving resistance with respect to the fluid. Attached here means, for example, that the structural elements are each connected to the outer skin of the vehicle by means of a fastening device. Alternatively, the structural elements can also be enclosed by the outer skin of the vehicle in such a way that they cannot become detached. Several structural elements can also be attached to the outer skin of the vehicle together with a fastening device. A larger number of structural elements increases the surface coverage of the vehicle's outer skin with structural elements. This can have a positive effect on the flow characteristics of the vehicle.

Preferably, the structural elements have a wedge shape with a wedge tip in a cross-section, whereby the structural elements are aligned in such a way that the wedge tip is aligned in the main direction of travel. By cross-section, we mean a section through the structural element in which the sectional plane is parallel to the main direction of travel of the vehicle.

Preferably, the smallest distance between two neighboring structural elements on the outer skin is at least 50 mm, preferably at least 100 mm, particularly preferably at least 150 mm. Tests have shown that a good reduction in air resistance can be achieved with a relatively small number of structural elements per unit area. This means that a vehicle, for example, can be fitted with the structural elements with relatively little effort. In variants, the minimum distance between two structural elements can also be less than 50 mm.

Preferably, the smallest distance between two neighboring structural elements on the outer skin is at most 500 mm, preferably at most 350 mm, in particular preferably at most 250 mm. Again, tests have shown that the effect of very large minimum distances between two neighboring structural elements is greatly reduced. Therefore, the minimum distance is preferably less than 500 mm. In particular embodiments, especially if, for example, the structural elements are particularly large, the minimum distance can also be more than 500 mm.

Preferably, a surface section of the outer skin of the vehicle provided with the structural elements has at most 100 structural elements per square meter, preferably at most 50, more preferably at most 10 structural elements, in particular, for example, 8 structural elements. In variants, more than 100 structural elements per square meter can also be provided. The fact that the flow conditions and thus the energy consumption of the vehicle can be optimized with a relatively small number of structural elements means that existing vehicles can also be retrofitted with the structural elements relatively easily. For this purpose, the structural elements can, for example, be connected to body parts of the vehicle with a material bond.

Preferably, the structural elements are arranged one behind the other in rows offset at right angles to the direction of flow. This achieves an efficient arrangement of the structural elements, whereby the structural elements are spaced as far apart as possible with relatively dense packing. In variants, the structural elements can also be arranged in non-staggered rows (Cartesian).

Preferably, two neighboring structural elements on the outer skin of the vehicle have a minimum spacing (smallest connecting line between the neighboring structural elements) in the range from 100% to 800%, in particular in the range from 250% to 500% of the maximum width of the structural element in the rows aligned at right angles to the direction of flow. In variants, however, the distance can also be less than 100% or more than 800% of the maximum width of the structural element.

Preferably, two structural elements arranged one behind the other in the direction of flow and adjacent to each other have a minimum distance (smallest connecting line between the neighboring structural elements) in the range from 100% to 800%, in particular in the range from 250% to 500% of the maximum width of the structural element. In variants, however, the distance can also be less than 100% or more than 800% of the maximum length of the structural element.

A further aspect of the invention is a mounting jig for mounting structural elements on a surface, comprising a frame and at least three alignment elements for aligning the structural elements, wherein the alignment elements are connected to the frame. The mounting jig allows a simple and quick parallel alignment of several structural elements on the outer skin of a vehicle. This allows a vehicle to be fitted with the structural elements easily and efficiently. Preferably, the mounting jig for attachment to a vehicle outer skin also comprises suction cups with which it can be easily and reversibly attached to a vehicle outer skin. Alternatively, it can also be designed without suction cups.

Also preferred is a mounting jig whose frame is made of a material that includes aluminium. This allows a robust construction with low weight. Alternatively, the frame can also be made of a material that does not include aluminium, for example stainless steel or a plastic.

A preferred embodiment of the assembly jig comprises a flexible mat, in particular a rubber mat, in which the alignment elements consist of recesses within the mat. The flexible mat, in particular the rubber mat, can form the frame of the assembly jig or supplement it. Preferably, the recesses are cut into the flexible mat by means of water jet cutting. The advantage of this embodiment is that such a mat is very robust and easy to store. It is also very compact. Furthermore, the mat can be quickly and reliably placed on a vehicle skin. In addition, the alignment elements can be cut into the mat in any number and orientation without incurring additional material costs. Alternatively, however, the mounting jig can be constructed differently and not comprise a flexible mat.

A further aspect of the invention is a façade element for mounting on a building envelope of a building which comprises at least 5, preferably at least 20 structural elements for reducing wind-induced force effects on the façade element, wherein the structural elements protrude from an outer side of the façade element with a height of at least 5 mm, preferably at least 8 mm, when the façade element is mounted on a building envelope. This results in a façade element that offers particularly low resistance in strong wind conditions or during a storm. Damage to the façade elements can thus be minimized in extreme weather conditions.

Preferably, the structural elements are designed and arranged in the same way as the structural elements described above in connection with the vehicles.

Preferably, a building envelope of a building is clad with at least one such façade element.

Preferably, a façade element provided with the structural elements has at most 100 structural elements per square meter, preferably at most 50, in particular preferably at most 10 structural elements, in particular for example 8 structural elements. In variants, more than 100 structural elements per square meter can also be provided.

A further aspect of the invention is a fluid conduit, in particular a ventilation duct, with a main flow direction and at least one inner wall, wherein the fluid conduit comprises at least 5, preferably at least 20 structural elements for reducing turbulence in the fluid conduit during operation of the fluid conduit, wherein the structural elements stand out from the inner wall with a height of at least 5 mm, preferably at least 8 mm. In this way, a largely laminar flow can be achieved in a fluid conduit, in particular in a ventilation duct. Turbulence and turbulence can thus be reduced. Noise levels and vibrations can also be reduced. Furthermore, less energy is required for ventilation. The structural elements can also be used for water pipes, especially for water pipes with a large cross-section. The fluid lines can also be used in hydroelectric power stations (high conveying speed) or as pipelines for oil or gas transport (long transport distances). Other areas of application are known to the skilled person.

Preferably, the structural elements are designed and arranged analogue to the structural elements described above in connection with the vehicles.

Preferably, an inner wall of a fluid conduit provided with the structural elements has at most 100 structural elements per square meter, preferably at most 50, in particular preferably at most 10 structural elements, in particular for example 8 structural elements. In variants, more than 100 structural elements per square meter can also be provided.

A further aspect of the invention is a sports suit which, when worn by a person in use, has a main direction of travel and comprises an outer skin which is exposed to a fluid, in particular water and/or air, during a journey in the main direction of travel. The outer skin comprises at least 5, preferably at least 20 structural elements for reducing the driving resistance to the fluid, wherein the structural elements stand out from the outer skin with a height of at least 5 mm, preferably at least 8 mm.

Preferably, the structural elements are designed and arranged analogue to the structural elements described above in connection with the vehicles.

Preferably, a sports suit provided with the structural elements has at most 100 structural elements per square meter, preferably at most 50, in particular preferably at most 10 structural elements, in particular for example 8 structural elements. In variants, more than 100 structural elements per square meter can also be provided.

Further advantageous embodiments and combinations of features of the invention result from the following detailed description and the entirety of the patent claims.

### BRIEF DESCRIPTION OF THE DRAWINGS

The drawings used to illustrate the embodiment example show:

FIG. 1a a first embodiment of the structural element in direct top view,

FIG. 1b the first embodiment of the structural element as a direct side view,

FIG. 1c the first embodiment of the structural element in cross-section,

FIG. 1d the underside of the first embodiment of the structural element in isometric plan view,

FIG. 2 a second embodiment of the structural element in isometric plan view,

FIG. 3 an isometric plan view of a vehicle with structural elements and

FIG. 4 an isometric plan view of a first assembly jig for structural elements,

FIG. 5 a second assembly jig for structural elements in isometric plan view.

In principle, identical parts are labelled with identical reference signs in the figures.

### Ways of Implementing the Invention

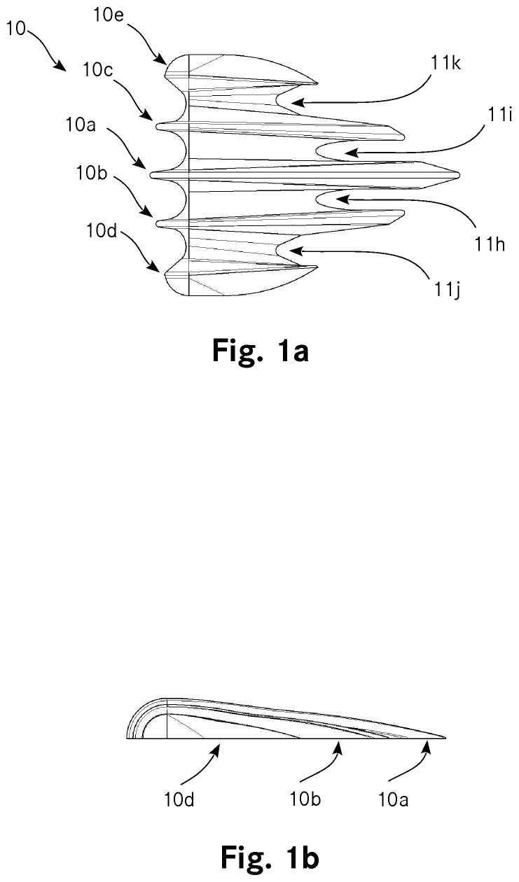

FIGS. 1a-1d show a structural element 10 according to the invention for attachment to an outer skin of a vehicle, in various views. FIG. 1a shows the upper side of the structural element 10 as a direct top view, FIG. 1b shows a direct side view of the structural element 10, FIG. 1c shows several cross-sections through the structural element 10 and FIG. 1d shows the underside of the structural element 10 in an isometric top view.

The structural element 10 comprises a main fin 10a placed in the center when viewed from above (FIG. 1a), a first secondary fin 10b, a second secondary fin 10c, a third secondary fin 10d and a fourth secondary fin 10e. The secondary fins 10b and 10c are each located to the side of the main fin 10a in the plan view, while the secondary fins 10d and 10e are located on the outside and each to the side of the secondary fin 10b and 10c respectively.

The first secondary fin 10b is arranged in such a way that it forms a first channel 11h together with the main fin 10a. The second secondary fin 10c forms a second channel 11i together with the main fin 10a. The third secondary fin 10d forms a third channel 11j together with the first secondary fin 10b. Similarly, the fourth secondary fin 10e forms a fourth channel 11k together with the second secondary fin 10c.

The length of the structural element 10 parallel to the first channel 11h corresponds to the maximum length of the main fin 10a and is 85 mm in this embodiment. Transverse to this length, i.e. transverse to the first channel 11h or the main fin 10a, the maximum extension of the structural element 10 is 67 mm. The maximum height of the structural element 10 again corresponds to the maximum height of the main fin 10a and is 10 mm. The total mass of the structural element 10 is 14.5 g.

The main fin 10a is an elongated elevation that is located in the center of the structural element 10. The main fin 10a is longer than the secondary fins 10b-10e. It has an elongated horizontal outline, whereby its maximum width (vertical in the image plane of FIG. 1a) is approximately 17% of its maximum length (horizontal in the image plane of FIG. 1a). The width of the main fin 10a differs depending on its height (perpendicular to the image plane of FIG. 1a). Within the upper 10% of its height, the width of the main fin 10a is constant over its entire length. In a central area of its height and along a large part of its length, the width of the main fin 10a increases linearly by approximately 100% from a first end to a second end. Towards the second end of the fin, the width then tapers from its maximum back to the initial value.

The maximum height of the main fin 10a (vertically in the image plane of FIG. 1b) is approximately 15% of the maximum length of the main fin 10a. The position of the maximum height has a distance along the length of the main fin to a first end of the main fin, which corresponds approximately to the maximum height. Thus, the maximum height divides the main fin 10a along the length into a first section between the maximum height and the first end of the main fin 10a and a second section between the maximum height and the second end of the main fin 10a. On the first section, the height from the end to the maximum height has the shape of a quarter circle, i.e. it rises vertically at the end of the fin and runs horizontally again at the maximum. On the second, longer section, the height of the main fin 10a falls continuously and almost linearly from the maximum height to the second end of the fin. This results in an essentially wedge-shaped side profile of the main fin 10a.

In cross-section (FIG. 1c, A-A, B-B or C-C), cut at a plane spanned by a height of the main fin 10a and a line (A, B or C in FIG. 1c) transverse to its maximum length, the height of the main fin 10a runs round around the fin ridge. This means that the maximum height of the main fin 10a is centered in relation to its width at any point along its length. The side walls of the main fin 10a extend substantially concave outwards away from the fin ridge of the main fin 10a until they are perpendicular to the height of the main fin 10a (horizontally in the image plane of FIG. 1c, A-A, B-B, C-C).

Along its length (horizontal in the image plane of FIG. 1a), the main fin 10a is always higher than all secondary fins 10b-10e and thus defines the side profile of the structural element 10 (FIG. 1b).

The first secondary fin 10b and the second secondary fin 10c are symmetrical to each other, whereby the mirror plane is spanned by the maximum length and the maximum height of the main fin. The fin crest of the two secondary fins 10b and 10c is inclined towards the main fin in the horizontal plane (FIG. 1a), i.e. the smallest distance between the fin crest at one fin end of a secondary fin 10b or 10c and the fin crest of the main fin 10a is shorter than at the other end of the secondary fin 10b or 10c.

At an average height, the secondary fins 10b and 10c have a triangular horizontal outline. This means that the width of a secondary fin 10b or 10c increases linearly along its maximum length from a first end towards a second end and, at the point of its maximum width, tapers again towards the second end in the direction of the main fin 10a. The maximum width is approximately 200% of the minimum width of the secondary fin 10b or 10c at the same height.

The course of the height of the secondary fins 10b and 10c is the same as that of the main fin 10a, whereby the height along the length of the secondary fins 10b or 10c is always smaller than that of the main fin 10a (FIG. 1b). The height of the secondary fin 10b or 10c is approximately 90% of the height of the main fin 10a.

Also in cross-section (FIG. 1c), cut at a plane spanned by a height of the main fin 10a and a line (A, B or C in FIG. 1c) transverse to its maximum length, the course of the side walls of the secondary fin 10b or 10c is very similar to that of the main fin 10a. Only in the sectional plane C (FIG. 1c) does the increasing width of the secondary fins 10b or 10 become apparent on the side facing away from the main fin 10a.

The secondary fins 10d and 10e arranged on the outside are shorter than the main fin 10a or the secondary fins 10b and 10c. Their maximum length is approximately 50% of the maximum length of the main fin 10a. In a region of their mean height, the secondary fins 10d and 10e retain their maximum width over a length section of approximately 40% of their maximum length, whereby their horizontal outline describes a wedge shape which is similar to the height profile of the main fin 10a. In this wedge shape, in turn, the side facing away from the neighboring secondary fin is rounded and tapers towards one end of the secondary fin 10d or 10e.

The height profile (FIG. 1b) of the third and fourth secondary fins 10d and 10e again corresponds to the height profile of the main fin 10a or the second and third secondary fins 10b and 10c.

The channels 11h and 11i, formed by the main fin 10a and a respective secondary fin 10b and 10c, run essentially parallel to the main fin 10a. Their length is limited by the length of the main fin 10a and the secondary fins 10b and 10c. In a central area along the length of the channel, the channel 11h or 11i is completely enclosed at the bottom by the side walls of the main fin 10a and a secondary fin 10b or 10c, i.e. in cross-section (see FIG. 1c) there is only one opening at the top. Towards the ends of the channel length, the channel floor is only completed when the flow element is attached to the outer skin of a vehicle. At the fin ends, there is therefore no continuous connection between the fins (10a and 10b or 10c) in a direction transverse to the length of the main fin 10a.

In cross-section (FIG. 1c), the channels are limited by the side walls of the respective fin (10a, 10b, 10c). The side walls of the main fin 10a and the secondary fins 10b and 10c run concavely away from the respective highest height of the fin in cross-section. The side walls of the main fin 10a and a secondary fin 10b or 10c meet in a central area of the channel length in such a way that a continuous, upwardly curved channel floor is formed. The cross-section of the channel floor changes along the length of the main fin 10a or along the length of the channel. Thus, the distance between the side walls of the main fin 10a and a secondary fin 10b or 10c is smaller at an average height at the position of intersection line C than at the same height, but at the position of intersection line A.

When a fluid flows through the first channel 11j or the second channel 11i, a change in the flow velocity of the fluid occurs.

The channel 11j is bordered by the side walls of the first secondary fin 11b and the third secondary fin 10d. Similarly, the channel 11k is formed by the secondary fins 10c and 10e. Due to the shorter and flatter secondary fins 10d and 10e, the channels 11j and 11k are shorter and flatter than the channels 11h and 11i located next to the main fin 10a.

The channels 11j and 11k also have an upwardly open round channel base in a central area of their length, which is formed by the side walls of the neighboring secondary fins 10b and 10d or 10c and 10e. However, their cross-section changes only insignificantly between lines A and C.

FIG. 1d shows the underside of the structural element 10 in isometric plan view. The structural element 10 comprises a fastening device 12 for attaching the structural element to the outer skin of a vehicle, consisting of a storage surface and five permanent magnets 12a-12e. The permanent magnets 12a-12e are each located within recesses on the underside of the fins 10a-10e. The shape of the permanent magnets 12a-12e corresponds approximately to the shape of the respective fin 10a-10e, with a smaller volume. Thus, the permanent magnet 12a under the main fin 10a is longer than the permanent magnets 12b-12e under the secondary fins 10b-10e.

The underside of the permanent magnets 12a-12e is flush with the storage surface. The support surface in turn surrounds the recesses within the fins 10a-10e and is flat. With the fastening device 12, the structural element can be attached to the outer skin of a vehicle without further manipulation. A vehicle can thus be equipped or retrofitted with one or more structural elements 10.

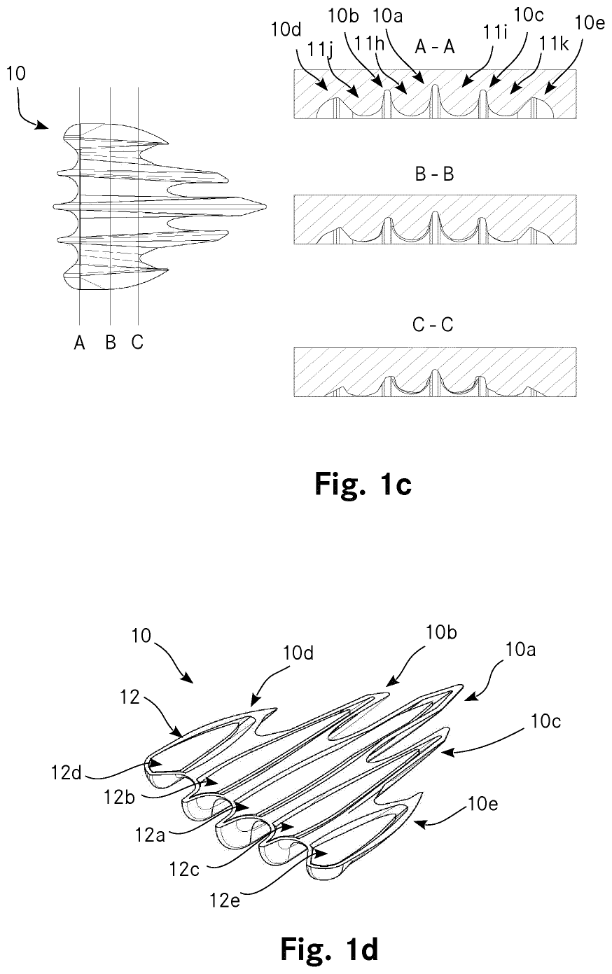

FIG. 2 shows an alternative embodiment of the invention, the structural element 20. The fin arrangement of the structural element 20 is similar to that of the structural element shown in FIG. 1a-FIG. 1d. The main fin 20a is also longer here than the neighboring first secondary fin 20b and the neighboring second secondary fin 20c. The first and second secondary fins 20b and 20c are in turn longer than the third secondary fin 20d and the fourth secondary fin 20e. The main fin 20a forms a first channel 21h with the first secondary fin 20b. Similarly, the main fin 20a forms the second channel 21i with the second secondary fin 20b. The first secondary fin 20b also forms a third channel 21j with the third secondary fin 20d and the second secondary fin 20c forms the fourth channel 21k with the fourth secondary fin 20e.

The shape, length and height of the structural element 20 results from the shape of the structural element 10 shown in FIG. 1a-FIG. 1d in combination with a plane which is spanned by the maximum height and a line transverse to the maximum length of the main fin 10a. A longer section of the structural element 10 lies on one side of the plane constructed in this way and a shorter section on the other side. To construct the structural element 20 in FIG. 2, the shorter section is discarded and the longer section is mirrored on the constructed plane and assembled with the first section. This results in a structural element 20 that is mirror-symmetrical to a plane running transverse to the main fin.

The effect of this structural element 20 on flows is the same if these flows are mirrored on a plane running transverse to the main fin. Such a symmetrical effect is particularly suitable for rail vehicles.

The change in cross-section of the first and second channels 20h and 20i of the structural element 20 is also symmetrical, i.e. the cross-section of the channel 20h or 20i differs at two positions on the same side of the plane of symmetry transverse to the main fin 20a, but not at positions on both sides of the plane of symmetry at the same distance from the plane of symmetry.

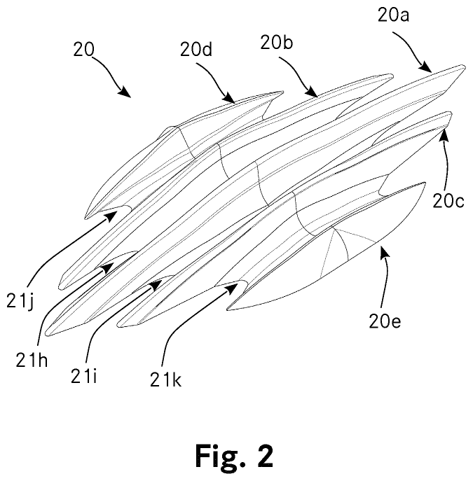

FIG. 3 shows a schematic representation of an oblique view of a van 30, wherein the outer skin is provided with structural elements 100.

The van 30 comprises a driver's cab 31 with a spoiler 32 and a box body 33 with an outer skin 35. In the present case, the spoiler 32 as well as the side surfaces and the top surface of the box body of the van 30 are provided with structural elements 100 at regular intervals. This reduces the air resistance of the van 30, which on the one hand reduces fuel consumption and on the other hand also reduces vibrations and thus noise levels. In this exemplary embodiment, the driver's cab 31 is not provided with the structural elements. In a further variant, the side surfaces of the driver's cab 31 are additionally provided with structural elements 100. It is clear to the skilled person that other vehicles can also be provided with the structural elements, in particular vehicles which are used on long journeys at high average speeds (e.g. long-distance lorries, etc.), railway wagons, but also cargo ships, etc.

The structural elements 100 have the same shape as the structural element 10 in FIG. 1a-FIG. 1d. They therefore have a wedge shape in a cross-section and in a side view. The structural elements 100 are aligned on the van 30 in such a way that the tip of the wedge is aligned in the main direction of travel.

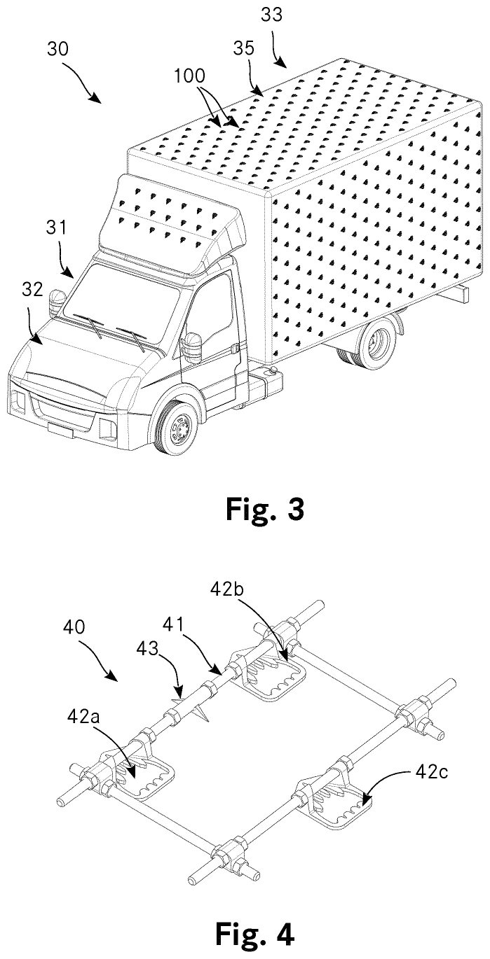

FIG. 4 shows a schematic representation of a mounting jig 40 for mounting structural elements (10, 20, 100) on an outer skin. The mounting jig 40 comprises a rectangular frame 41, to which three alignment elements 42a-42c are attached, with which the three structural elements can be positioned and attached to an outer skin. It also comprises a contact piece 43 with which it can contact an outer skin in addition to the alignment elements 42a-42c, whereby the contact piece 43 additionally supports the assembly jig 40.

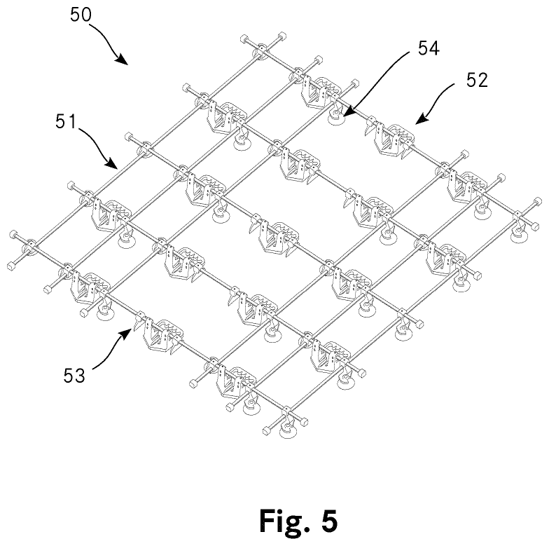

FIG. 5 shows a second mounting jig 50 for mounting structural elements (10, 20, 100). This assembly jig 50 comprises a flexible aluminium frame 51, with which a plurality of structural elements can be positioned and fastened to an outer skin. It comprises a plurality of abutment pieces, e.g. abutment piece 53 and a plurality of alignment elements, e.g. alignment element 52. The mounting jig 50 can be reversibly attached to an outer skin via suction cups, e.g. suction cup 54. This makes it very easy to position this mounting jig on an outer skin and then attach it firmly.

The invention is not limited to the embodiments shown. In particular, the fins can have a different height profile and also, for example, differently shaped side walls. In variants, the structural element can also comprise more than five fins or only three fins, i.e. one main fin and two secondary fins. The channels can have a different length relative to each other. The ends of the fins can also have a different shape to that shown here. Vehicles other than the vehicle shown can also be equipped with the structural elements according to the invention. Likewise, the structural elements can be attached to the vehicle in an arrangement other than that shown. The assembly jig according to the invention also has alternative embodiments. For example, it can comprise different numbers of alignment elements.

To summarize, a structural element with a main fin and at least two secondary fins, which together with the main fin form channels with a changing cross-section, creates a structural element which is suitable for effectively reducing the flow resistance acting on a vehicle and which is simple and inexpensive to manufacture.

1. A structural element for attachment to an outer skin of a vehicle, comprising;
a) a main fin;
b) at least one first and one second secondary fin, arranged next to the main fin in such a way that a first channel is formed between the first secondary fin and the main fin and a second channel is formed between the second secondary fin and the main fin;
wherein
c) the first channel and the second channel each have a change in cross-section such that when a fluid flows through the first channel or the second channel, a change in a flow velocity of the fluid occurs.

2. The structural element according to claim 1, wherein a maximum width transverse to a longitudinal direction of the first channel and the second channel increases in the direction of the longitudinal direction at an opening angle between 0.1° and 20°.

3. The structural element according to claim 1, wherein the main fin has a change in cross-section in the direction of the first channel and the second channel.

4. The structural element according to claim 1, wherein the main fin comprises a main fin ridge and the first secondary fin comprises a first secondary fin ridge, wherein a minimum distance between the main fin ridge and the secondary fin ridge is between 50% and 300% of a maximum height of the main fin.

5. The structural element according to claim 1, wherein the structural element further comprises a third secondary fin and a fourth secondary fin, wherein
a) the third secondary fin is arranged directly next to the first secondary fin in such a way that a third channel is formed between the third secondary fin and the second secondary fin, and wherein
b) the fourth secondary fin is arranged directly next to the second secondary fin in such a way that a fourth channel is formed between the fourth secondary fin and the second secondary fin,
wherein the first channel and the second channel are longer than the third channel and the fourth channel, and
wherein the same number of secondary fins is located on both longitudinal sides of the main fin.

6. (canceled)

7. The structural element according to claim 1, wherein the structural element is mirror-symmetrical to a plane extending transversely to the main fin.

8. The structural element according to claim 1, wherein the structural element is mirror-symmetrical to a plane running parallel to the main fin.

9. The structural element according to claim 1, wherein the main fin has a tangent angle of at most 30° at one end to an underside of the structural element.

10. The structural element according to claim 5, wherein a maximum height of the secondary fins increases towards the main fin and the main fin has the highest maximum height.

11. The structural element according to claim 5, wherein a height of the main fin increases steadily over a partial length of at least 60%, of an entire length of the main fin.

12. (canceled)

13. The structural element according to claim 11, wherein all fins each have a fin end directly adjoining the partial length, which is located within a surface whose extension parallel to the length of the main fin is at most 20% of the length of the main fin.

14. The structural element according to claim 5, wherein a length of the first, second, third and fourth secondary fins is in each case less than a length of the main fin and the lengths of the secondary fins increase towards the main fin.

15. The structural element according to claim 1, wherein a length of the structural element in the direction of the first channel is between 30 mm and 120 mm and a width of the structural element transverse to the first channel is between 20 mm and 100 mm and a maximum height of the main fin is between 5 mm and 20 mm.

16. (canceled)

17. (canceled)

18. (canceled)

19. The structural element according to claim 1, further comprising a fastening device for attaching the structural element to the outer skin of a vehicle the vehicle comprising a transport vehicle, a passenger car, a rail vehicle, an aircraft or a watercraft, wherein the fastening device comprises at least one permanent magnet for fixing the structural element to the outer skin of the vehicle.

20. (canceled)

21. A vehicle comprising an outer skin which is exposed to a fluid comprising water air, during a journey in a main direction of travel, and at least 5 structural elements according to claim 1 attached to the outer skin of the vehicle in order to reduce a driving resistance with respect to the fluid.

22. The vehicle according to claim 21, wherein the structural elements have a wedge shape with a wedge tip in a cross-section, the structural elements being aligned in such a way that the wedge tip is aligned in the main direction of travel.

23. (canceled)

24. A façade element for mounting on a building envelope of a building, wherein the façade element comprises at least 5 structural elements according to claim 1 for reducing wind-induced force effects on the façade element.

25. A building comprising a building envelope with at least one façade element according to claim 24.

26. A fluid conduit comprising a ventilation duct, with a main flow direction comprising at least one inner wall, wherein the fluid conduit comprises at least 5 structural elements according to claim 1 for reducing turbulence in the fluid conduit during operation of the fluid conduit, wherein the structural elements stand out from the inner wall.

27. A sports suit which, worn by a person, has a main direction of travel when in use, the sports suit comprising an outer skin which is exposed to a fluid comprising water or air, during a journey in the main direction of travel, wherein the outer skin comprises at least 5 structural elements according to claim 1 for reducing the driving resistance with respect to the fluid, the structural elements lifting from the outer skin.
